(19) United States
(12) Patent Application Publication
(10) Pub. No.: US 2013/0211733 A1
(43) Pub. Date: Aug. 15, 2013

(54) ANALYSIS METHOD TO ACHIEVE A DETAILED ANALYSIS OF A REACTOR EFFLUENT

(71) Applicants: Guy Baeveghems, Ecaussinnes (BE); Eric Detemmeran, Haine-Saint-Pierre (BE); Dominique Viennet, Nivelles (BE); Mary Gaëtan, Ixelles (BE); Eric Romers, Ottignies (BE)

(72) Inventors: Guy Baeveghems, Ecaussinnes (BE); Eric Detemmeran, Haine-Saint-Pierre (BE); Dominique Viennet, Nivelles (BE); Mary Gaëtan, Ixelles (BE); Eric Romers, Ottignies (BE)

(73) Assignee: TOTAL RESEARCH & TECHNOLOGY FELUY, FELUY (BE)

(21) Appl. No.: 13/701,767

(22) PCT Filed: Jun. 15, 2011
(86) PCT No.: PCT/EP11/59906

§ 371 Date: Jan. 2, 2013

(30) Foreign Application Priority Data
Jun. 16, 2010 (EP) 10166091.8

(51) Int. Cl. G06F 19/00

(52) U.S. Cl. CPC G06F 19/703
USPC 702/24

(57) ABSTRACT

The present invention relates to a method suitable for establishing an analysis of a reactor effluent which is gaseous in process conditions and presents a gas phase and a liquid phase after cooling, comprising:
providing a reactor producing a gaseous effluent at a temperature of at least about 100° C. and a pressure ranging from 0.05 MPa to 10 MPa which is at least under one gaseous phase and one liquid phase after cooling,
providing a sampling vessel having connecting means capable to be filled with a sample of the above gaseous effluent and keep said sample,
putting said sampling vessel under vacuum,
connecting said sampling vessel to the outlet of the reactor containing the effluent gas to fill said sampling vessel with a sample of the effluent gas,
recovering the sampling vessel,
cooling it to get a gas phase and a liquid phase,
determining the gas mass and composition by analysis, sampling vessel pressure, sampling vessel volume and sampling vessel temperature measurement,
determining the liquid mass by weighting of total sample and substraction of the gas mass or by use of an internal standard with or without the use of a compatible solvent,
determining the liquid detailed composition by any means,
determining the detailed composition of the sample, the reactor effluent, by combination of these data.

### FIELD OF THE INVENTION

The present invention relates to an analysis method to achieve a detailed analysis of a reactor effluent. Olefins are traditionally produced from petroleum feedstocks by catalytic or steam cracking processes. These cracking processes, especially steam cracking, produce light olefin(s), such as ethylene and/or propylene, from a variety of hydrocarbon feedstock. Ethylene and propylene are important commodity petrochemicals useful in a variety of processes for making plastics and other chemical compounds.

The limited supply and increasing cost of crude oil has prompted the search for alternative processes for producing hydrocarbon products. The MTO process produces light olefins such as ethylene and propylene as well as heavy hydrocarbons such as butenes. Said MTO process is the conversion of methanol or dimethylether by contact with a molecular sieve. The interest in the methanol to olefin (MTO) process is based on the fact that methanol can be obtained from coal or natural gas by the production of synthesis gas which is then processed to produce methanol.

The effluent produced by a MTO process is a complex mixture comprising the desired light olefins, unconverted oxygenates, by-product oxygenates, heavier hydrocarbons and large amounts of water.

Olefins can also be produced by dehydration of the corresponding alcohol. Ethanol can be obtained by fermentation of carbohydrates. Made up of organic matter from living organisms, biomass is the world's leading renewable energy source. The effluent produced by the ethanol dehydration comprises essentially unconverted ethanol, water, ethylene, acetaldehyde.

### BACKGROUND OF THE INVENTION

The reactor effluents of the above processes which are homogeneous in the reactor present several phases after cooling, this makes the sampling and the analysis of said effluent not easy. The analysis of a gaseous effluent which is multiphasic after cooling has the following drawbacks:

Usual sampling of cracking furnace effluent for example is made on a long period of sampling with separation of liquids and gas and complex data recording and analyses to calculate the effluent composition and it doesn't lead to a reliable mass balance. Cooling of sample and separate gas and liquids characterization: high duration of the sample, complexity of the sampling system (cooling source, gas meter, temperature and pressure measurement, exchanger and separator), a lot of uncertainty causes (process: modification of the operating condition, sampling: a lot of measurements in non ideal condition (out), loss of liquids on surfaces and so difficulty to weigh it, . . . )

On line analysis: expensive, high maintenance cost, very complex (to obtain full mass balance), fouling on the sampling lines. In this case the difficulty is the fact that the detailed characterization needs several complementary analyses and the link between analyses to calculate the global mass balance is an added constraint.

The following prior arts relate to the on line analysis.

U.S. Pat. No. 5,266,270 describes an on-line test and analysis equipment equivalent for establishing a material balance of a chemical reaction comprising: a reactor; an injection system for a charge having a certain flow and composition, connected to the reactor; instrumentation for measuring the flow and composition of the charge; a heater to heat the reactor so as to provide a gaseous effluent; first analysis instrumentation to provide a qualitative and quantitative analysis of effluents contained in sampling valves; expansion device for the effluents; second analysis instrumentation for expanded effluent; an instrument to measure the volume of the effluents connected to the outlet of the first analysis means; and instrumentation connected to the instrumentation for measuring the flow and composition of the charge, to the instrument for measuring the volume, and to the first and second analysis instrumentation, the processing instrumentation being capable of determining a material balance from the measurements of flow and composition of the charge and the analysis of the charge, and from the analysis of the effluents. At col 3 lines 45+ is mentioned “ . . . After the expansion stage, it can be particularly advantageous to perform a condensation step (low pressure) which delivers a condensate that is taken into account in the material balance to the extent that it is possible to weigh it and determine its composition. When the conversion rates are high (>10%), the presence of heavy condensates can lead to performing an additional condensation step before step a). The condensate is analyzed qualitatively and quantitatively and is taken in account in the material balance . . . ”. At col 4 lines 26+ is mentioned “ . . . According to another embodiment, the equipment can comprise a first condensation means at the output of the expansion means, which makes it possible to analyze the condensate and to analyze the uncondensed expanded gas effluent . . . ”. At col 7 lines 60+ is mentioned ”. . . . This system, object of the present invention, can be used for multiple applications, particularly:

A) in refining: catalytic cracking, hydrocracking, reforming, hydroisomerization, hydrogenation,

B) in petrochemistry : transformation of aromatics (isomerization, disproportionation, hydrodealkylation), various oxidations (oxidation of toluene to benzaldehyde, methanol to formal),

C) in CO+H2 chemistry (synthesis gas treatment) synthesis of methanol conversion of methanol to hydrocarbons conversion of CO+H2 to higher alcohols . . . ”.

U.S. Pat. No. 7,625,526 describes a reactor assembly comprising:
at least one flow-through reactor for performing at least one chemical reaction, the flow-through reactor comprising:
a reaction chamber, comprising a reaction zone, the reaction chamber being connected to at least one reactor inlet for at least one reactant, upstream of the reaction zone, and to at least one reactor outlet for the effluent stream from the reaction zone, downstream of the reaction zone,
at least one analyser for subjecting the effluent stream to an analysing procedure, each reactor outlet being connected to said at least one analyser by an effluent conduit, wherein the reactor assembly comprises:
at least one dilution fluid supply means, for adding at least one dilution liquid to the effluent stream, downstream of the reaction zone,
a base block having a plurality of reactor chamber channels therein, each reactor chamber channel being accessible from a first face of the base block;

WO 2009130392 relates to a process for the preparation of C2-C8 hydrocarbons by cracking catalytically one or more hydrocarbons which have been obtained from natural fat or a derivative thereof. At page 8 lines 5+ are mentioned the sampling and analysis techniques used “ . . . Reactor and sampling Test equipment consists of feed vessel and pump (Neste technology), mass flow controllers (Brooks) for nitrogen and air, gas/liquid mixer, pre-heater for product mixture, reactor and furnace, pressure controller (Kammer), gas/liquid separator and sample collector. Nitrogen was used as internal standard for mass balance calculation and simultaneously as carrier for gaseous product. The gas/liquid mixture was fed to a heated pre-heater whose temperature was set to 300° C. Gas and liquid products were analysed on-line with Agilent 5890 and 6890 GC and furthermore fraction analyses from liquid product off-line were carried out with another Agilent 6890 GC. The temperature of the feed and liquid product lines were 50° C. and the temperature of the gas line was 100° C. In-situ regeneration option was also available wherein air was introduced into the reactor at a temperature of 500° C. The state of regeneration was measured with an on-line CO/CO2-analyser type Siemens Ultramat 22P. Analysis On-line sampling and analysis were automated with a timer to take and collect 9-10 gas and liquid samples during a day. The pressure of the gaseous sample line was adjusted into constant pressure and the concentration of hydrocarbons (Ci-C7) and permanent gases (H2, O2, N2, CO and CO2) were analysed simultaneously. Permanent gases were separated with HayeSepQ and molecular sieve connected in series and hydrocarbons with a capillary column. Gas sample quantification was achieved with external calibration. A separation column was used for liquid on-line samples, which was of the type DB-1. The identified compounds ranged from methane up to boiling point 221° C. Fraction analyses on off-line samples were carried out with a DB-1 column . . . ”.

U.S. Pat. No. 6,821,500 describes an apparatus for thermal conversion of one or more reactants to desired end products includes an insulated reactor chamber having a high temperature heater such as a plasma torch at its inlet end and, optionally, a restrictive convergent-divergent nozzle at its outlet end. In a thermal conversion method, reactants are injected upstream from the reactor chamber and thoroughly mixed with the plasma stream before entering the reactor chamber. The reactor chamber has a reaction zone that is maintained at a substantially uniform temperature. The resulting heated gaseous stream is then rapidly cooled by passage through the nozzle, which “freezes” the desired end product(s) in the heated equilibrium reaction stage, or is discharged through an outlet pipe without the convergent-divergent nozzle. The desired end products are then separated from the gaseous stream. At col 13 lines 27+ is described the continuous analysis system” . . . . All instrumentation used in the following Examples except for the gas chromatograph (GC) was directly interfaced to a data acquisition system for continuous recording of system parameters during a test run. Once the specified process power levels, pressure, and gas flow rates were established, the gas stream was continuously sampled by the gas chromatograph for a period of 7 minutes before the chromatograph gas sample was acquired to ensure that a representative sample was obtained. This sampling period represents approximately three times the time required to completely purge the sample line. The pressure downstream of the quench nozzle was controlled by a mechanical vacuum pump and flow control valve. Depending on the test conditions, the test pressure can be independently adjusted between atmospheric pressure and approximately 100 torr. The experiment reached steady state in a period of 1 minute or less. Steady state operation was verified by a continuously reading residual gas analyzer (RGA). All cooling water flow rates and inlet and outlet temperatures were monitored and recorded allowing a complete system energy balance to be calculated . . . ”.

As described in the above prior arts the on line analysis requires a huge equipment and it seems very difficult to get the mass balance.

U.S. Pat. No. 7,611,622 describes a sampling of gas in a bag and a sampling of liquid. This prior art relates to the operation of dual-riser fluidized catalytic cracking (FCC) units to produce olefins and/or aromatics from light hydrocarbon feedstocks, and in particular from feedstocks rich in C3 and/or C4 hydrocarbons. At col 14 lines 6+ is mentioned “ . . . At half-hour intervals, product gases were collected in gas sampling bags and analyzed off-line using a gas chromatograph. The liquid product was collected in two stages; a first sample was withdrawn after about 3.5 hours of reactor operation, and a second sample was recovered at the end of the reaction, about 6.5 hours from the start of the reaction . . . ”. At col 15 lines 5+ is cited “ . . . A mass balance was performed using the average flow rates for the feed and effluent gases and for various time intervals. The results of the mass balance calculations are presented in Table 3. In Table 3, the amount of C₆+ for the 0-0.6 h interval was estimated, assuming no coke formation, from mass balance using the analyses of the gas bag samples because no liquid product was taken at that time . . . ”.

We have discovered a much more simple method wherein is provided a sampling vessel having connecting means capable to be filled with a sample of the gaseous effluent and keep said sample, said sampling vessel is put under vacuum and then connected to the outlet of the reactor containing the effluent gas to fill said sampling vessel with a sample of the effluent gas. The sample is analysed, including by weighting, to determine the composition of the effluent gas.

### BRIEF SUMMARY OF THE INVENTION

The present invention relates to a method suitable for establishing an analysis of a reactor effluent which is gaseous in process conditions and presents a gas phase and a liquid phase after cooling, comprising :
providing a reactor producing a gaseous effluent at a temperature of at least about 100° C. and a pressure ranging from 0.05 MPa to 10 MPa which is at least under one gaseous phase and one liquid phase after cooling,
providing a sampling vessel having connecting means capable to be filled with a sample of the above gaseous effluent and keep said sample,
putting said sampling vessel under vacuum,
connecting said sampling vessel to the outlet of the reactor containing the effluent gas to fill said sampling vessel with a sample of the effluent gas,
recovering the sampling vessel,
cooling it to get a gas phase and a liquid phase,
determining the gas mass and composition by analysis, sampling vessel pressure, sampling vessel volume and sampling vessel temperature measurement,
determining the liquid mass by weighting of total sample and substraction of the gas mass or by use of an internal standard with or without the use of a compatible solvent,
determining the liquid detailed composition by any means,
determining the detailed composition of the sample, the reactor effluent, by combination of these data.

Analysis of the gas sample can be made by gas chromatography, mass spectometry or any equivalent means.

Analysis of the liquid sample can be made by gas chromatography, mass spectometry or any equivalent means.

Advantageously the volume of the sampling vessel is high enough to get accurate measurements. Said volume is advantageously at least about 1 liters, preferably it ranges from about 2 liters to about 100 liters, and more preferably from about 2 liters to about 6 liters.

Advantageously the effluent gas is at a temperature ranging from 100° C. to 850° C.

By way of example, the gaseous effluent at a temperature of at least about 100° C. and a pressure ranging from 0.1 MPa to 1 MPa which is sampled comprises at least one gaseous phase and one liquid phase after cooling at the temperatures generally used to make the various analysis to establish the mass balance.

The present invention is of high interest for the effluent gases containing water. One can cite the effluent of the furnace in a steam cracking, the effluent of an MTO reactor and the effluent of an alcohol dehydration reactor.

### DETAILED DESCRIPTION OF THE INVENTION

As regards the steam cracking, steam cracking of hydrocarbons (also referred as thermal cracking or pyrolysis) is a non-catalytic petrochemical process that is widely used to produce olefins such as ethylene, propylene, butenes, butadiene, and aromatics such as benzene, toluene, and xylenes. Basically, a hydrocarbon feedstock such as naphtha, gas oil or other fractions of whole crude oil that are produced by distilling or otherwise fractionating whole crude oil, is mixed with steam which serves as a diluent to keep the partial pressure of hydrocarbon molecules low. The steam/hydrocarbon mixture is preheated to from about 400° C. to about 650° C., and then enters the reaction zone where it is very quickly heated to an hydrocarbon thermal cracking temperature. Thermal cracking is accomplished without the aid of any catalyst. This process is carried out in a pyrolysis furnace (steam cracker) at pressures in the reaction zone ranging from is about 10 to about 30 psig. Pyrolysis furnaces have internally thereof a convection section and a radiant section. Preheating is accomplished in the convection section, while cracking occurs in the radiant section. By way of example of steam cracking one can cite:
steam cracking of naphtha which is an hydrocarbon cut having from 5 to 12 carbon atoms and advantageously from 5 to 9 carbon atoms,
steam cracking of ethane to make essentially ethylene,
steam cracking of propane and
steam cracking of butane.

After the thermal cracking, the effluent from the pyrolysis furnace (the cracking zone) contains gaseous hydrocarbons of great variety, e.g., from one to thirty-five carbon atoms per molecule and steam. These gaseous hydrocarbons can be saturated, monounsaturated, and polyunsaturated, and can be aliphatic, alicyclics, and/or aromatic. The cracked gas also contains significant amounts of molecular hydrogen (hydrogen). The cracked product is then further processed in a fractionation section to produce, as products of the plant, various separate individual streams of high purity such as hydrogen, ethylene, propylene, mixed hydrocarbons having four carbon atoms per molecule, fuel oil, and pyrolysis gasoline. Each separate individual stream aforesaid is a valuable commercial product.

As regards the MTO process, methanol, dimethyl ether or more generally oxygen-containing, halogenide-containing or sulphur-containing organic feedstock is contacted with a catalyst comprising a molecular sieve such as SAPO or ZSM-5 under conditions effective to convert the oxygen-containing, halogenide-containing lo or sulphur-containing organic feedstock to olefin products. In this process a feedstock containing an oxygen-containing, halogenide-containing or sulphur-containing organic compound contacts the catalyst in a reaction zone of a reactor at conditions effective to produce light olefins, particularly ethylene and propylene. Typically, the oxygen-containing, halogenide-containing or sulphur-containing organic feedstock is contacted with the catalyst when the oxygen-containing, halogenide-containing or sulphur-containing organic compounds is in vapour phase. Alternately, the process may be carried out in a liquid or a mixed vapour/liquid phase. In this process, converting oxygen-containing, halogenide-containing or sulphur-containing organic compounds, olefins can generally be produced at a wide range of temperatures. An effective operating temperature range can be from about 200° C. to 700° C. At the lower end of the temperature range, the formation of the desired olefin products may become markedly slow. At the upper end of the temperature range, the process may not form an optimum amount of product. An operating temperature of at least 300° C., and up to 575° C. is preferred.

The pressure also may vary over a wide range. Preferred pressures are in the range of about 5 kPa to about 5 MPa, with the most preferred range being of from about 50 kPa to about 0.5 MPa. The foregoing pressures refer to the partial pressure of the oxygen-containing, halogenide-containing, sulphur-containing organic compounds and/or mixtures thereof.

The process can be carried out in any system using a variety of transport beds, although a fixed bed or moving bed system could be used. Advantageously a fluidized bed is used. It is particularly desirable to operate the reaction process at high space velocities. The process can be conducted in a single reaction zone or a number of reaction zones arranged in series or in parallel. Any standard commercial scale reactor system can be used, for example fixed bed, fluidised or moving bed systems. The commercial scale reactor systems can be operated at a weight hourly space velocity (WHSV) of from 0.1 hr⁻¹ to 1000 hr⁻¹.

One or more inert diluents may be present in the feedstock, for example, in an amount of from 1 to 95 molar percent, based on the total number of moles of all feed and diluent components fed to the reaction zone. Typical diluents include, but are not necessarily limited to helium, argon, nitrogen, carbon monoxide, carbon dioxide, hydrogen, water, paraffins, alkanes (especially methane, ethane, and propane), aromatic compounds, and mixtures thereof. The preferred diluents are water and nitrogen. Water can be injected in either liquid or vapour form.

The oxygenate feedstock is any feedstock containing a molecule or any chemical having at least an oxygen atom and capable, in the presence of the catalyst, to be converted to olefin products. The oxygenate feedstock comprises at least one organic compound which contains at least one oxygen atom, such as aliphatic alcohols, ethers, carbonyl compounds (aldehydes, ketones, carboxylic acids, carbonates, esters and the like). Representative oxygenates include but are not necessarily limited to lower straight and branched chain aliphatic alcohols and their unsaturated counterparts. Examples of suitable oxygenate compounds include, but are not limited to: methanol; ethanol; n-propanol; isopropanol; C₄-C₂₀ alcohols; methyl ethyl ether; dimethyl ether; diethyl ether; di-isopropyl ether; formaldehyde; dimethyl carbonate; dimethyl ketone; acetic acid; and mixtures thereof. Representative oxygenates include lower straight chain or branched aliphatic alcohols, their unsaturated counterparts.

Analogously to these oxygenates, compounds containing sulphur or halides may be used. Examples of suitable compounds include methyl mercaptan; dimethyl sulfide; ethyl mercaptan; di-ethyl sulfide; ethyl monochloride; methyl monochloride, methyl dichloride, n-alkyl halides, n-alkyl sulfides having n-alkyl groups of comprising the range of from about 1 to about 10 carbon atoms; and mixtures thereof. Preferred oxygenate compounds are methanol, dimethyl ether, or s a mixture thereof.

As regards the alcohol dehydration, one can cite WO 2009-098262. This prior art relates to a process for the dehydration of an alcohol having at least 2 carbon atoms to make the corresponding olefin, comprising:
introducing in a reactor a stream (A) comprising at least an alcohol, optionally water, optionally an inert component, contacting said stream with a catalyst in said reactor at conditions effective to dehydrate at least a portion of the alcohol to make an olefin,
recovering from said reactor an olefin containing stream (B),
Wherein
the catalyst is :
   a crystalline silicate having a ratio Si/Al of at least about 100, or
   a dealuminated crystalline silicate, or
   a phosphorus modified zeolite,
the WHSV of the alcohols is at least 2 h⁻¹,

The alcohol is any alcohol provided it can be dehydrated to the corresponding olefin. By way of example mention may be made of alcohols having from 2 to 10 carbon atoms. Advantageously the invention is of interest for ethanol, propanol, butanol and phenylethanol.

The weight proportions of respectively alcohol, water and inert component are, for example, 5-100/0-95/0-95 (the total being 100). The stream (A) can be liquid or gaseous.

The reactor can be a fixed bed reactor, a moving bed reactor or a fluidized bed reactor. A typical fluid bed reactor is one of the FCC type used for fluidized-bed catalytic cracking in the oil refinery. A typical moving bed reactor is of the continuous catalytic reforming type. The dehydration may be performed continuously in a fixed bed reactor configuration using a pair of parallel “swing” reactors. The various preferred catalysts of the present invention have been found to exhibit high stability. This enables the dehydration process to be performed continuously in two parallel “swing” reactors wherein when one reactor is operating, the other reactor is undergoing catalyst regeneration. The catalyst of the present invention also can be regenerated several times.

The pressure can be any pressure but it is more easy and economical to operate at moderate pressure. By way of example the pressure of the reactor ranges from 0.5 to 30 bars absolute (50 kPa to 3 MPa).

The temperature ranges from 280° C. to 500° C., advantageously from 280° C. to 450° C.

The WHSV of the alcohol ranges advantageously from 2 to 20 h⁻¹.

The stream (B) comprises essentially water, olefin, the inert component (if any) and unconverted alcohol. Said unconverted alcohol is supposed to be as less as possible. The olefin is recovered by usual fractionation means. Advantageously the inert component, if any, is recycled in the stream (A) as well as the unconverted alcohol, if any. Unconverted alcohol, if any, is recycled to the reactor in the stream (A).

As regards the sampling vessel, it is known in itself. It can be made of steel or Aluminum with or without internal coating (for example PTFE) depending of the need to avoid adsorption of some components on the internal walls. It comprises a set of valves to make easily vacuum inside and connect it to the line which carries the effluent gas of the reactor.

As regards the recovery of the sampled gas and analysis of said sample, it is known in itself.
By way of example the sampling vessel can be a metallic sampling bottle having a volume between 4 and 7 liters.
It is put under vacuum using a vaccum pump.
The weighting of the bottle is obtained with a weighing scales.
The bottle is connected to the outlet of a reactor, the sample is taken.
The bottle is disconnected and weighted in the laboratory.
The pressure in the bottle is measured by means of a precise pressure gauge and the temperature is recorded.
The detailed analysis of the gas is obtained by gas chromatography with an Agilent® 6890.
The gas quantity is calculated by means of the gas composition, the pressure, the temperature and the volume of the bottle.
The liquid mass calculation is obtained by difference between the mass of sample and the gas mass; an adjustment of the volume of gas is done to take into account the volume of the liquid (iterative calculation made one or several times depending of the volume of liquid; one time is sufficient if the volume is less than 5% of the is bottle). A representative sample of liquid is injected on one gas chromatograph Agilent® 6890 for detailed composition.
The composition of the reactor effluent is obtained by the sum of gas and liquid and balance to 100%.

### EXAMPLE

A metallic sampling bottle has a volume of 5.06 liters.

It is put under vacuum using a vaccum pump

The weighting of the bottle is obtained with a weighing scales

The bottle is connected to the outlet of a SAPO 34 MTO reactor, which means an MTO reactor operating with a SAPO 34 catalyst, the sample is taken

The bottle is disconnected and weighted in the laboratory: the sample weight is 40.210 g

The pressure in the bottle is measured by means of a precise pressure gauge: 2.1 bara; the temperature is recorded: 24.4° C.

The detailed analysis of the gas is obtained by gas chromatography with an Agilent® 6890; see table 1

The gas quantity is calculated by means of the gas composition, the pressure, the temperature and the volume of the bottle; see table 1

The liquid mass calculation is obtained by difference between the mass of sample and the gas mass; an adjustment of the volume of gas is done to take into account the volume of the liquid (iterative calculation made one or several times depending of the volume of liquid; one time is sufficient if the volume is less than 5% of the bottle); see table 2

A representative sample of liquid is injected on one gas chromatograph Agilent® 6890 for detailed composition: see table 2

The composition of the reactor effluent is obtained by the sum of gas and liquid and balance to 100%: see table 3

TABLE 1

GAZ

| | Conc | Weight |
|---|---|---|
| | wt % | gram |
| Total | 100.0 | 15.878 |
| Hydrogen | 0.078 | 0.012 |
| Carbonmonoxide | 0.043 | 0.007 |
| Carbondioxide | 0.040 | 0.006 |
| Methane | 0.892 | 0.142 |
| Ethylene | 31.767 | 5.048 |
| Ethane | 1.089 | 0.173 |
| Propylene | 41.354 | 6.571 |
| Propane | 3.294 | 0.523 |
| Cyclopropane | 0.004 | 0.001 |
| Butenes | 13.646 | 2.168 |
| Butanes | 0.901 | 0.143 |
| Butadienes | 0.152 | 0.024 |
| C5's | 3.156 | 0.501 |
| C6's | 1.599 | 0.254 |
| Others | 0.132 | 0.014 |
| Methanol | 0.026 | 0.004 |
| dimethylEther | 1.556 | 0.247 |
| Acetaldehyde | 0.081 | 0.013 |
| Oxygenates | 0.164 | 0.026 |

TABLE 2

LIQUID

| Sample | gram | 40.21 |
|---|---|---|
| weight | | |
| Gas phase | gram | 15.878 |
| Total | gram | 24.332 |
| Composition: | wt % | M (g) |
| Ethylene | 0.0029 | 0.0007 |
| Propylene | 0.005 | 0.0012 |
| Butenes | 0.023 | 0.005 |
| Butanes | 0.000 | 0.000 |
| C5's | 0.000 | 0.000 |
| C6's | 0.000 | 0.000 |
| Others | 0.021 | 0.005 |
| Methanol | 0.2967 | 0.0720 |
| dimethylEther | 0.0688 | 0.0170 |
| Acetaldehyde | 0.0562 | 0.0140 |
| Ethanol | 0.0199 | 0.0050 |
| Oxygenates | 0.285 | 0.069 |
| Water | 99.2219 | 24.1430 |

TABLE 3

| | GAZ | LIQUID | TOTAL | |
|---|---|---|---|---|
| | Weight | Weight | Weight | Conc |
| | gram | gram | gram | wt % |
| Total | 15.878 | 24.332 | 40.210 | 100.0% |
| Hydrogen | 0.012 | | 0.012 | 0.03% |
| Carbonmonoxide | 0.007 | | 0.007 | 0.02% |
| Carbondioxide | 0.006 | | 0.006 | 0.02% |
| Methane | 0.142 | | 0.142 | 0.35% |
| Ethylene | 5.048 | 0.0007 | 5.048 | 12.55% |
| Ethane | 0.173 | | 0.173 | 0.43% |
| Propylene | 6.571 | 0.0012 | 6.572 | 16.34% |
| Propane | 0.523 | | 0.523 | 1.30% |
| Cyclopropane | 0.001 | | 0.001 | 0.00% |
| Butenes | 2.168 | 0.005 | 2.174 | 5.41% |
| Butanes | 0.143 | 0.000 | 0.143 | 0.36% |
| Butadienes | 0.024 | | 0.024 | 0.06% |
| C5's | 0.501 | 0.000 | 0.501 | 1.25% |
| C6's | 0.254 | 0.000 | 0.254 | 0.63% |
| Others | 0.014 | 0.005 | 0.019 | 0.05% |
| Methanol | 0.004 | 0.0720 | 0.076 | 0.19% |
| dimethylEther | 0.247 | 0.0170 | 0.264 | 0.66% |
| Acetaldehyde | 0.013 | 0.0140 | 0.027 | 0.07% |
| Ethanol | | 0.0050 | 0.005 | 0.01% |
| Oxygenates | 0.026 | 0.069 | 0.095 | 0.24% |
| Water | | 24.1430 | 24.143 | 60.04% |

1. Method suitable for establishing an analysis of a reactor effluent which is gaseous in process conditions and presents a gas phase and a liquid phase after cooling, comprising :
providing a reactor producing a gaseous effluent at a temperature of at least about 100° C. and a pressure ranging from 0.05 MPa to 10 MPa which is at least under one gaseous phase and one liquid phase after cooling,
providing a sampling vessel having connecting means capable to be filled with a sample of the above gaseous effluent and keep said sample,
putting said sampling vessel under vacuum,
connecting said sampling vessel to the outlet of the reactor containing the effluent gas to fill said sampling vessel with a sample of the effluent gas,
recovering the sampling vessel,
cooling it to get a gas phase and a liquid phase,
determining the gas mass and composition by analysis, sampling vessel pressure, sampling vessel volume and sampling vessel temperature measurement,
determining the liquid mass by weighting of total sample and substraction of the gas mass or by use of an internal standard with or without the use of a compatible solvent,
determining the liquid detailed composition by any means,
determining the detailed composition of the sample, the reactor effluent, by combination of these data.

2. Method according to claim 1 wherein the volume of the sampling vessel is at least about 1 liters.

3. Method according to claim 1 wherein the volume of the sampling vessel ranges from about 1 liters to about 100 liters,

4. Method according to claim 1 wherein the effluent is selected among the effluent of the furnace in a steam cracking, the effluent of an MTO reactor and the effluent of an alcohol dehydration reactor.
